(19) United States
(12) Patent Application Publication
(10) Pub. No.: US 2010/0070461 A1
(43) Pub. Date: Mar. 18, 2010

(54) DYNAMIC CONSUMER-DEFINED VIEWS OF AN ENTERPRISE'S DATA WAREHOUSE

(76) Inventors: Shon Vella, Orem, UT (US); Nick Nikols, Draper, UT (US)

Correspondence Address: SCHWEGMAN, LUNDBERG & WOESSNER/NOVELL, PO BOX 2938, MINNEAPOLIS, MN, 55402, US

(21) Appl. No.: 12/209,704

(22) Filed: Sep. 12, 2008

(51) Int. Cl. G06F 7/06; G06F 17/30

(52) U.S. Cl. 707/603; 707/E17.014; 707/E17.044

(57) ABSTRACT

Techniques for dynamic consumer-defined views of an enterprise's data warehouse are provided. A requester, such as a consumer, defines custom attribute aggregations associated with a plurality of data sources. The custom attribute aggregations define a schema for a resource-defined view of the data warehouse. Data operations are dynamically processed against the data sources in response to the schema to produce the resource-defined view.

### BACKGROUND

Increasingly enterprises are acquiring and using a plethora of information analysis applications to mine their information sources (data sources). Each such application may utilize a same data source and/or may produce its own data source as output. Some enterprise applications may cover one aspect of the enterprises business, such as Human Resources (HR) for employee affairs using a PeopleSoft® data source, whereas other applications address an entirely different aspect of the enterprise's business, such as customer relations using a Structured Query Language (SQL) data source.

Enterprises have attempted, with limited success, to integrate disparate enterprise data sources for purposes of providing unified presentations of enterprise information for market analysis and/or for purposes of accessing disparate data mining and analysis tools that attempt to leverage and bridge information available within the enterprise.

Often the available bridging solutions are not generic enough and are in fact too specific to a given enterprise. This means that when upgrades or enhancements to an enterprise's data sources occur, then corresponding updates or enhancements have to be made to that enterprise's proprietary bridging systems. So, the maintenance and support for bridging systems become issues within an enterprise; resulting in added human resources and expense for an enterprise.

In addition, valuable market opportunities can be lost within the enterprise when that enterprise is not capable of timely and adequately tying its data sources together for analysis. The competitive edge of an enterprise in today's highly competitive and electronic environment is often closely intertwined with the ability of the enterprise to timely uncover relationships within its data sources.

Accordingly, improved techniques for generating database views of enterprise data are desirable.

### SUMMARY

In various embodiments, techniques for dynamic consumer-defined views of an enterprise's data warehouse are presented. More specifically, and in an embodiment, a method for dynamically generating a resource-defined view is provided. More specifically, a resource-defined view request is received from a resource. Next, a determination is made as to whether the resource-defined view request can be satisfied via an existing data warehouse service or via direct access to the data warehouse. Finally, a data warehouse view of the data warehouse is presented, as defined by the resource-defined view request, to the resource.

### BRIEF DESCRIPTION OF THE DRAWINGS

FIG. 1 is a diagram of a method for dynamically generating a resource-defined view, according to an example embodiment.

FIG. 2 is a diagram of another method for dynamically generating a resource-defined view, according to an example embodiment.

FIG. 3 is a diagram of resource-defined view generation system, according to an example embodiment.

FIG. 4 is a diagram of another resource-defined view generation system, according to an example embodiment.

### DETAILED DESCRIPTION

A “resource” includes a service, system, device, directory, data store, user, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “identity” is something that is formulated from one or more identifiers, secrets, and/or attributes that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc. As more and more identifiers are accumulated, a confidence in a particular identity grows stronger and stronger. In an embodiment, the identifier is a signature or a pair of signatures. For example, the signature of an identity service that vouches for a crafted identity, the signature of a principal associated with the crafted identity, or the signature of both the identity service and the principal.

“Authentication” is the process of validating the association of identifiers and secrets according to a policy, which is specific to the context in which the resulting identity is to be used. Thus, when identifiers are validated within a context specific to how an identity is to be used, it is authentication.

A “data source” as used herein can include a relational database, an object-oriented database, a directory, a collection of files logically associated with one another, and/or various combinations of these things. A “data repository” may be used interchangeably with a “data warehouse” and a data warehouse includes multiple disparate data sources logically interfaced together. Some example data sources can include PeopleSoft®, SAP®, Oracle®, Sybase®, custom Structured Query Language (SQL) enabled databases, etc.

A “view” is a special type of data query that is processed against the data warehouse. It is processed against the data sources of the data warehouse when requested to produce a dynamic results table that represents the results of the query. An “attribute” is a field of a particular data source, such as a Last Name field of a relational database (data source). A view can include calculations or operations that tabulate or aggregate multiple attributes, such as “total sales for 2008,” where multiple sales for multiple tables are totaled to produce a single aggregated “total sales for 2008” field of the view.

In an embodiment, the network discussed herein may be a local area network (LAN (wired and/or wireless)), the Internet (wired and/or wireless), or any wide-area network (WAN (wired and/or wireless)).

Various embodiments of this invention can be implemented in existing network architectures. For example, in some embodiments, the techniques presented herein are implemented in whole or in part in the Novell® network, identity management, directory services, and proxy server products, distributed by Novell®, Inc., of Provo, Utah.

Of course, the embodiments of the invention can be implemented in a variety of architectural platforms, operating and server systems, or applications. Any particular architectural layout or implementation presented herein is provided for purposes of illustration and comprehension only and is not intended to limit aspects of the invention.

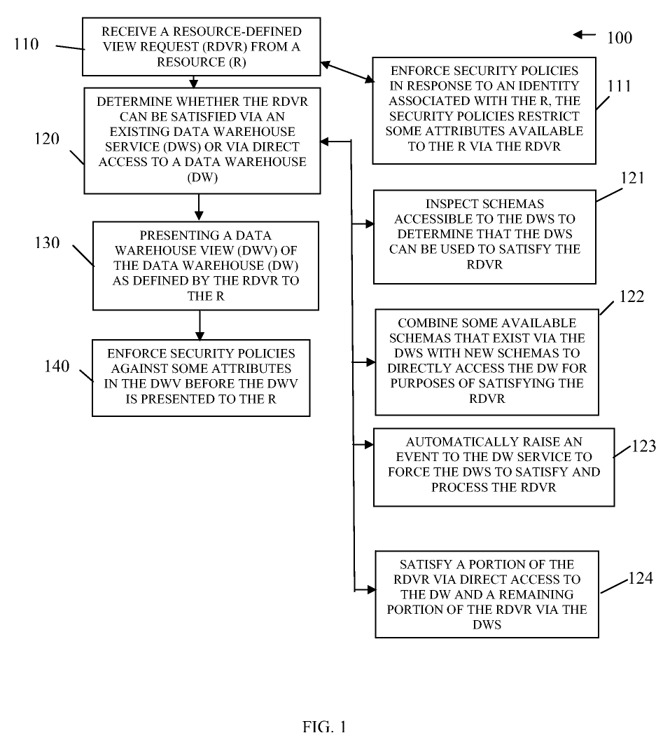

It is within this context that embodiments of the invention are now discussed with reference to the FIGS. 1-4.

FIG. 1 is a diagram of a method 100 for dynamically generating a resource-defined view, according to an example embodiment. The method 100 (hereinafter “view generation service”) is implemented in a machine-accessible and readable medium. The view generation service is also operational over a network and the network can be wired, wireless, or a combination of wired and wireless.

At 110, view generation service receives a resource-defined view request from a resource. That is, a resource (e.g., user, consumer, administrator, database analyst, automated application, etc.) custom defines attributes (database fields, World-Wide Web (WWW) page frames, etc.) that span multiple data sources of an enterprise (e.g. relational databases, directories, websites, etc.). The resource may also aggregate the attributes into calculations, substitutions, and/or logical expressions. The resource is defining a view of specific attributes that the resource wants to see in a single virtual table. As an example, a resource, such as a user, may define a view as being a virtual table that includes the following fields: “Customer Account Number, Customer Name, Average Purchase Total Per Visit, Total Purchases for 2008,” the fields can span multiple different enterprise databases.

According to an embodiment, at 111, the view generation service enforces security policies in response to an identity associated with the resource. The security policies restrict some attributes that are available to the resource via the resource-defined view request. So, the resource is authenticated for secure access to data sources or secure access to the data warehouse of the enterprise.

Once authenticated the resource has an identity; that identity is associated with security roles or permissions and in some cases those roles or permissions can restrict some attributes or aggregations that the resource attempts to define in the resource-defined view request. The security policies associated with the resource identity may also define how to handle attributes that the resource is not able to access, such as completely redacting out any presence of the attributes from any resource-defined view so that the resource is not aware that information is missing from any view produced. In other cases, the security policies can insert X's or some other characters or images into the view produced to show that information is present but the actual content of that information is not available for viewing to the resource.

At 120, the view generation service determines whether the resource-defined view request can be satisfied via an existing data warehouse service or via direct access to an enterprise's data warehouse. The existing data warehouse service is an application or module of an enterprise that permits view processing. The view generation service can leverage such a service to handle some requests or the view generation service can completely bypass such a service to directly access the backend data sources (databases) associated with the enterprise data warehouse. This determination can be done in a variety of manners.

For example, at 121, the view generation service inspects static schemas that are accessible to and pre-defined within the existing data warehouse service to determine when the existing data warehouse service can be enlisted into providing the view that satisfies the resource-defined view request.

In another case, at 122, the view generation service combines some available static schemas that exist via the existing data warehouse service with new dynamically-generated schemas to directly access the data warehouse for purposes of satisfying the resource-defined view request. So, a subset of the resource-defined view request may be satisfied via static schemas that exist within the existing data warehouse service whereas other schemas are dynamically generated attribute aggregations for the data sources of the enterprise data warehouse.

In one situation, at 123, the view generation service can force the existing data warehouse service to produce a desired view that satisfies all or some of the resource-defined view request by raising specific events within a processing environment of the data warehouse service, where those events are recognized and processed by the data warehouse service to produce views.

Again, at 124, an embodiment is illustrated where the view generation service satisfies some portion of the resource-defined view request via direct access to the backend data warehouse and its data sources and at the same time satisfies a remaining portion of the resource-defined view request via the data warehouse service by manipulating existing interfaces used by that data warehouse service.

At 130, the view generation service presents to the resource a data warehouse view of the data warehouse according to the dictates of or definitions included within the resource-defined view request. This is done in real time and dynamically by processing commands and operations for each data source to process queries and computations, such as joins, merges, etc. The commands and operations are mapped from the resource-defined view request to specific data source interfaces or application programming interfaces (API's) by the view generation service and then processed. Again, in some cases, the view generation service can enlist an existing data warehouse service to translate parts of the request to specific interface commands and operations. Results from the processing are dynamically assembled and organized into a virtual table that reflects the resource-defined view of the data warehouse, which is presented to the requesting resource.

According to an embodiment, the view generation service can also enforce security policies against some attributes of the data warehouse view before that data warehouse view is presented to the requester. Thus, security policies can be enforced on the front end, when the resource initially defines the view request and can also be enforced immediately before the data warehouse view is presented to the requesting resource. This can ensure that security policies are enforceable at multiple points in the workflow of view requesting and presentation. It also ensures that policies can be dynamically injected, changed, and enforced after a view request is submitted but before that view is presented to the resource. The security policies can also be based on identities of the target resources (data sources or attributes of a particular data source) and/or the identities of the requesting resources (users or automated applications).

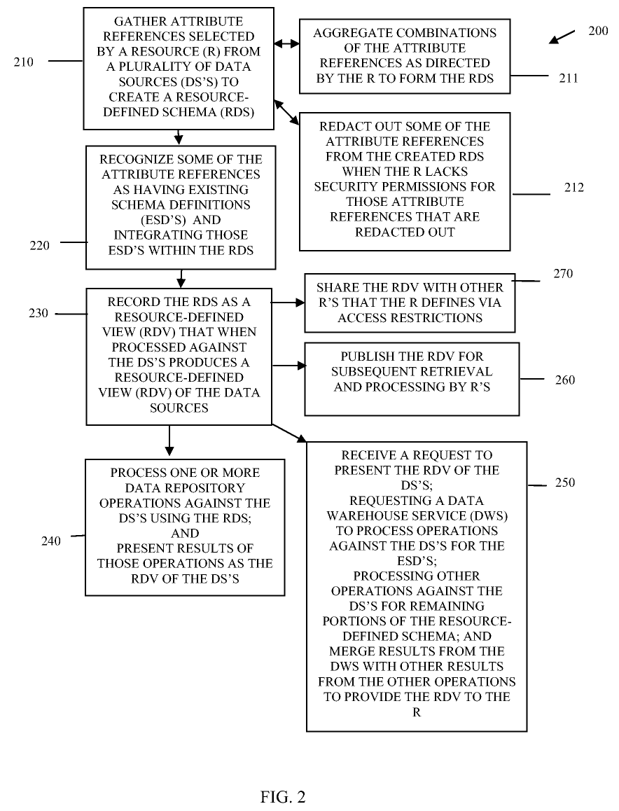

FIG. 2 is a diagram of another method 200 for dynamically generating a resource-defined view, according to an example embodiment. The method 200 (hereinafter “view interface service”) is implemented in a machine-accessible and readable medium. The view interface service is operational over a network. The network may be wired, wireless, or a combination of wired and wireless.

The view interface service represents another aspect or component that interacts with the view generation service represented by the method 100 of the FIG. 1. Specifically, the view interface service is described from the point of view of a resource's interactions that initially defines a particular view of an enterprise's data warehouse.

The view interface service presents itself as a custom-defined interface that includes its own Graphical User Interface (GUI) and/or Application Programming Interface (API) that a resource can access. The resource can be a user, that accesses a set of GUI tools to define and generate a view or the resource can be an automated application that accesses commands of the API to define and generate the view.

At 210, the view interface service gathers attribute references selected by a resource (such as a consumer or a user) from a plurality of data sources (such as databases and/or directories) to create a resource-defined schema. The resource defined schema defines in a normalized format attributes from the data sources and aggregations of those attributes that are to be included and/or computed to form a resource-defined view of an enterprise's data warehouse.

So, in an embodiment, at 211, the view interface service aggregates combinations of the attribute references as directed by the resource that dynamically interacts with the view interface service. This is done to form the resource-defined schema.

According to an embodiment, at 212, the view interface service redacts out some of the attribute references from the created resource-defined schema when the resource lacks security permissions for those attribute references that are redacted out. Thus, the resource can be constrained at an attribute level of security from making references to some attributes from some data sources. If such attempts are made a log can be maintained and reported; warnings can be levied if warranted; and/or any such attribute references are removed from the resource-defined schema once created or before created.

At 220, the view interface service recognizes some of the attribute references as having existing schema definitions. In response to this, the view interface service integrates those existing schema definitions within the resource-defined schema. In other words, existing attribute aggregations from the data warehouse that are maintained by existing data warehouse services can be leveraged via their existing available schema definitions and integrated into the resource-defined schema.

At 230, the view interface service records the resource defined-schema definition as a resource-defined view that when processed against the data sources produces the resource defined view of the data sources.

According to an embodiment, at 240, the view interface service processes one or more data repository operations against the data sources using the resource-defined schema. The results of those operations are then presented as the resource-defined view of the data sources. So, operations that each data source recognizes are processed against each data source to produce the results that are defined as the view.

In an embodiment, at 250, the view interface service receives a request to present the resource-defined view of the data sources. In response, the view interface service requests a data warehouse service to process operations against the data sources for the existing schema definitions known to the data warehouse service. The view interface service also processes other operations against the data sources for remaining portions of the resource-defined schema. Results from the data warehouse service are then merged with other results acquired from processing the other operations to provide the resource-defined view to the requesting resource. The data warehouse service is used to leverage some attribute aggregations to improve the dynamic processing associated with producing the resource-defined view for the requester.

In another situation, at 260, the view interface service publishes the resource-defined view for subsequent search, retrieval, and processing by other requesting resources. So, a library of available consumer or resource-defined views can be created and as specific views are created they are published to the library for all users to see and access. This improves accessibility and reuse of the views.

Similarly, at 270, the view interface service shares the resource-defined view with other resources that the resource defines via access restrictions associated with the view. The resource can define what resource identities can access the view via the access restrictions that can be defined within a policy or carried as metadata with the view.

It is noted that a single user can created multiple views or multiple users can share and access a single view. Moreover, a single user-defined view can nest within its schema definition other user-defined views.

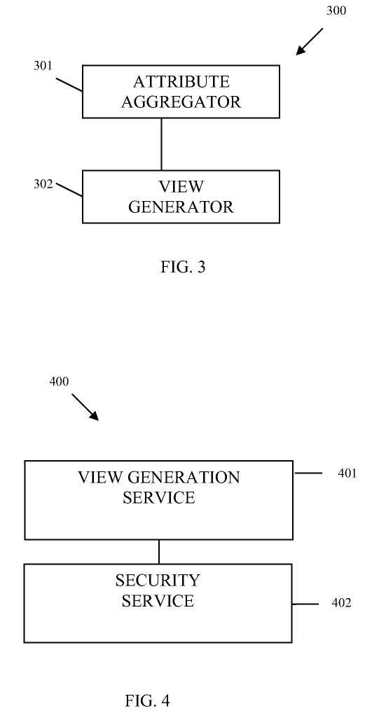

FIG. 3 is a diagram of resource-defined view generation system 300, according to an example embodiment. The resource-defined view generation system 300 is implemented in a machine-accessible and computer-readable storage medium and is operational over a network and processes on one or more machines (computers or processor-enabled devices) of the network. The network may be wired, wireless, or a combination of wired and wireless. In an embodiment, the resource-defined view generation system 300 implements among other things the view generation service represented by the method 100 of FIG. 1 and the view interface service represented by the method 200 of the FIG. 2.

The resource-defined view generation system 300 includes an attribute aggregator 301 and a view generator 302. Each of these will now be discussed in turn.

The attribute aggregator 301 is implemented in a computer-readable storage medium as instructions that process on a machine (computer or processor-enabled device) over the network. Example processing associated with the attribute aggregator 301 was presented in detail above with reference to the methods 100 and 200 of the FIGS. 1 and 2, respectively.

The attribute aggregator 301 interacts with a resource, such as a consumer or user, to define attribute (e.g., fields of a database, etc.) aggregations (computations, logical expressions, conditional expressions, etc.) that span multiple data sources (databases, directories, etc.). The attribute aggregations are stored as resource-defined view schemas (normalized definitions or notations).

According to an embodiment, the attribute aggregator 301 presents itself as a unified interface for the resource to define the resource-defined views. This can be a GUI in the case where the resource is a user or consumer and can be an API in the case where the resource is an automated application or service.

In an embodiment, the data sources are organized as a data warehouse. The data sources are disparate types of data sources, such as files, relational databases, object-oriented databases, directories, etc. The data sources are presented logically as one data warehouse accessible to the resource via the attribute aggregator 301.

The view generator 302 is implemented in a computer-readable storage medium as instructions that process on a machine of the network. The view generator 302 processes the resource-defined view schemas, which are produced by the attribute aggregator 301 (via interactions with a resource), as data operations against the data sources to produce resource-defined views of the data sources.

The view generator 302 translates the schemas to process operations (such as queries, computations, etc.) in a data source-specific interface for purposes of producing results that are presented in the resource-defined views.

According to an embodiment, the view generator 302 uses a data warehouse service to process the data operations when the view generator 302 determines that existing schemas are available via that data warehouse service that include the resource-defined view schemas. So, the view generator 302 can leverage and use legacy services of an enterprise's data architecture to assist in dynamically assembling the resource-defined views.

In another case, the view generator 302 directly accesses separate interfaces associated with each data source to process the data operations. The results are then normalized from those disparate data operations into the resource-defined views for requesters.

FIG. 4 is a diagram of another resource-defined view generation system 400, according to an example embodiment. The resource-defined view generation system 400 is implemented in a machine-accessible and computer-readable storage medium and is to be processed by machines (computers or processor-enabled devices) over a network. The network may be wired, wireless, or a combination of wired and wireless. In an embodiment, the resource-defined view generation system 400 performs, among other things, the processing associated with the method 100 of the FIG. 1; performs the processing associated with the method 200 of the FIG. 2; and presents another perspective and in some ways enhanced perspective to the system 300 of the FIG. 3.

The resource-defined view generation system 400 includes a view generation service 401 and a security service 402. Each of these will now be discussed in turn.

The view generation service 401 is implemented in a computer-readable storage medium as instructions that process on a machine (computer or processor-enabled device) of the network. Example processing techniques associated with the view generation service 401 were presented above with reference to the methods 100 and 200 of the FIGS. 1 and 2, respectively and with respect to the system 300 of the FIG. 3.

The view generation service 401 defines a custom-defined view of attributes that are dispersed throughout a plurality of data sources to create a custom-defined view of those data sources.

According to an embodiment, the view generation service 401 uses some statically defined schemas to assist in defining the custom-defined view.

In another case, the view generation service 401 dynamically defines a schema that defines the custom-defined view.

In yet another embodiment, the view generation service 401 publishes the custom-defined view for subsequent use by other resources of the network or enterprise. This promotes reuse and usability of the custom-defined view.

The security service 402 is implemented in a computer-readable storage medium as instructions that process on a machine of the network. The network may be wired, wireless, or a combination of wired and wireless.

The security service 402 enforces security when a resource attempts to view the custom-defined view.

According to an embodiment, the security service 402 redacts out portions of the custom-defined view in response to security policies associated with the resource. The policies can dictate that the portions be completely removed from the custom-defined view such that a requester is unaware that information or that the portions were redacted out. In another case, the policies can dictate that the portions are X'd out or blacked out within the custom-defined view such that a requester is aware that the information or portions existed but the content is not available to the requester.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
receiving a resource-defined view request from a resource;
determining whether the resource-defined view request can be satisfied via an existing data warehouse service or via direct access to a data warehouse; and
presenting a data warehouse view of the data warehouse as defined by the resource-defined view request to the resource.

2. The method of claim 1, wherein receiving further includes enforcing security policies in response to an identity associated with the resource, wherein the security policies restrict some attributes available to the resource via the resource-defined view request.

3. The method of claim 1, wherein determining further includes inspecting schemas accessible to the existing data warehouse service to determine that the existing data warehouse service can be used to satisfy the resource-defined view request.

4. The method of claim 1, wherein determining further includes combining some available schemas that exist via the existing data warehouse service with new schemas to directly access the data warehouse for purposes of satisfying the resource-defined view request.

5. The method of claim 1, wherein determining further includes automatically raising an event to the data warehouse service to force the data warehouse service to satisfy and process the resource-defined view request.

6. The method of claim 1, wherein determining further includes satisfying a portion of the resource-defined view request via direct access to the data warehouse and a remaining portion of the resource-defined view request via the data warehouse service.

7. The method of claim 1, wherein presenting further includes enforcing security policies against some attributes in the data warehouse view before the data warehouse view is presented to the resource.

8. A machine-implemented method, comprising:
gathering attribute references selected by a resource from a plurality of data sources to create a resource-defined schema;
recognizing some of the attribute references as having existing schema definitions and integrating those existing schema definitions within the resource-defined schema; and
recording the resource defined schema as a resource-defined view that when processed against the plurality of data sources produces a resource-defined view of the data sources.

9. The method of claim 8 further comprising:
processing one or more data repository operations against the plurality of data sources using the resource-defined schema; and
presenting results of those operations as the resource-defined view of the data sources.

10. The method of claim 8 further comprising:
receiving a request to present the resource-defined view of the data sources;
requesting a data warehouse service to process operations against the data sources for the existing schema definitions;
processing other operations against the data sources for remaining portions of the resource-defined schema; and
merging results from the data warehouse service with other results from the other operations to provide the resource-defined view to the requester.

11. The method of claim 8 further comprising, publishing the resource-defined view for subsequent retrieval and processing by requesters.

12. The method of claim 8 further comprising, sharing the resource-defined view with other resources that the resource defines via access restrictions.

13. The method of claim 8, wherein gathering further includes aggregating combinations of the attribute references as directed by the resource to form the resource-defined schema.

14. The method of claim 8, wherein gathering further includes redacting out some of the attribute references from the created resource-defined schema when the resource lacks security permissions for those attribute references that are redacted out.

15. A machine-implemented system, comprising:
an attribute aggregator implemented in a computer-readable storage medium and to process on a network; and
a view generator implemented in a computer-readable storage medium and to process on the network;
wherein the attribute aggregator interacts with a resource to define attribute aggregations that span multiple data sources and wherein the attribute aggregations are stored as resource-defined view schemas, and wherein the view generator processes the resource-defined view schemas as data operations against the data sources to produce resource-defined views of the data sources.

16. The system of claim 15, wherein the attribute aggregator presents itself as a unified interface for the resource to define the resource-defined views.

17. The system of claim 15, wherein the data sources are organized as a data warehouse.

18. The system of claim 15, wherein the view generator uses a data warehouse service to process the data operations when the view generator determines existing schemas are available via the data warehouse service that include the resource-defined view schemas.

19. The system of claim 15, wherein the view generator directly accesses separate interfaces associated with each data source to process the data operations and normalizes results from those data operations as the resource-defined views for requestors.

20. The system of claim 15, wherein the data sources include a plurality of disparate types of data sources that are logically associated with one another via the attribute aggregator.

21. A machine-implemented system comprising:
a view generation service implemented in a computer-readable storage medium and to process on a network; and
a security service implemented in a computer-readable storage medium and to process on the network;
the view generation service is to define a custom-defined view of attributes that are dispersed throughout a plurality of data sources to create a custom-defined view of the data sources, and wherein the security service is to enforce security when a resource attempts to view the custom-defined view.

22. The system of claim 21, wherein the view generation service uses some static defined schemas to assist in defining the custom-defined view.

23. The system of claim 21, wherein the view generation service dynamically defines a schema that defines the custom-defined view.

24. The system of claim 21, wherein the security service redacts out portions of the custom-defined view in response to security policies associated with the resource.

25. The system of claim 21, wherein the view generation service publishes the custom-defined view for subsequent use by other resources.
